(19) United States
(12) Patent Application Publication
(10) Pub. No.: US 2012/0180579 A1
(43) Pub. Date: Jul. 19, 2012

(54) LARGE VOLUME PIPETTE TIP FOR LOADING IN AN AUTOMATED LIQUID HANDLER

(75) Inventors: Lee Brady, Lisle, IL (US); Larry Schoell, Shorewood, IL (US); Gary V. Millard, Lisle, IL (US); Timothy E. Cloutier, Lake Villa, IL (US)

(73) Assignee: PERKINELMER HEALTH SCIENCES, INC., Waltham, MA (US)

(21) Appl. No.: 13/006,328

(22) Filed: Jan. 13, 2011

(51) Int. Cl. B01L 3/02

(52) U.S. Cl. 73/864.01

(57) ABSTRACT

A pipette tip having lower, upper and central portions and a bore extending therethrough. The lower portion is elongated and projects in a first direction from the central portion, and is sized and shaped for insertion into a test-tube. The bore is adapted for aspirating and dispensing a large volume of the liquid. The upper portion projects from the central portion in a second direction opposing the first direction, and its terminal end is sized and shaped to sealingly engage an automated pipetting system. The central portion and a corresponding portion of the bore are enlarged with respect to both the upper and lower portions to allow the pipette tip to hold the large volume of the liquid. The central portion can have a cross-section substantially rectangular in shape. The cross-section can have a height at least substantially similar to the diameter of the lower portion of the pipette tip and a width significantly greater than the diameter of the lower portion of the pipette tip.

### BACKGROUND OF THE INVENTION

1. Field of the Invention

The present disclosure is related to pipette tips and, more particularly, to large volume pipette tips, and to systems and methods incorporating the same.

2. Description of the Related Art

As micropipetting has become common, more and more labs and other facilities are using automated micropipetting systems. A microplate with 96 wells on 9 mm centers in an 8 well by 12 well array is often used with dispense apparatus. Early prior art dispense devices used one dispenser and moved the dispenser in the X-Y direction 96 times to dispense into each of the 96 wells. Because only one tip is used in such a system, there was nothing at the time restricting the diameter of the tip. As a result, the tips could have as large a diameter as necessary to hold the desired volume of liquid.

Over time, however, dispense apparatus were developed to dispense an entire row at one time, indexed to fill the entire plate. Apparatus have been further developed since that time to incorporate entire arrays of 96, 384 or more tips simultaneously filling an entire plate.

When a large volume of fluid (i.e., a volume approaching 5 mL or more) is to be measured or dispensed, a micropipetting system cannot be used, as the tips, being used to fill wells spaced on 9 mm centers, often are too narrow to hold enough liquid. Accordingly, for such situations, the apparatus operator typically must remove the micropipetting head from the dispense apparatus and replace it with a head configured for large volume pipette tips, or worse, must remove and replace an entire arm of the apparatus in situations where the head is not modular. Apparatus configuration changes such as these reduce the efficiency and productivity of the lab or other facility.

### BRIEF SUMMARY OF THE INVENTION

The present disclosure is directed toward pipette tips for use with automated liquid dispensing equipment. In particular, the present disclosure is directed toward pipette tips adapted to provide for simultaneous, large volume pipetting with several tips positioned in close proximity to each other, allowing for high speed, multi-well dispensing, even where the wells in a tray are extremely close to each other. Embodiments of the pipette tip have a long, narrow tip with a tapered end that can provide access to the full volume in a narrow tube or the bottom of a deep-well block. Embodiments of the pipette tip also can be impregnated with carbon material, allowing the tip to be used in liquid level detection systems.

In one aspect, the present disclosure is directed toward a pipette tip having a lower portion, an upper portion, a central portion located between the lower and upper portions, and a bore extending along a longitudinal axis through the pipette tip from the lower portion to the upper portion. The lower portion of the pipette tip is elongated and projects in a first direction from the central portion, and is sized and shaped for insertion into a test-tube. The bore is adapted for aspirating and dispensing a large volume of the liquid. The upper portion of the pipette tip projects from the central portion in a second direction opposing the first direction, and its terminal end is sized and shaped to sealingly engage an automated pipetting system. The central portion of the pipette tip and a corresponding portion of the bore is enlarged with respect to both the upper and lower portions of the pipette tip to allow the pipette tip to hold the large volume of the liquid. The central portion has a cross-section substantially rectangular in shape when cut in a plane perpendicular to the longitudinal axis of the pipette tip. The rectangular cross-section of the central portion has a height at least substantially similar to the diameter of the lower portion of the pipette tip and a width significantly greater than the diameter of the lower portion of the pipette tip.

In specific, non-limiting embodiments, the lower portion of the pipette tip is cylindrical, has a frusto-conical tip, is at least three inches long, is at least four inches long, is at least three times as long as the corresponding length of the central portion of the pipette tip, is at least four times as long as the corresponding length of the central portion of the pipette tip, is less than half an inch in diameter, or is less than a quarter inch in diameter. In other specific, non-limiting embodiments, the rectangular central portion has a height measuring less than half inch, a height measuring less than one third inch, or a width measuring more than one inch. In other specific, non-limiting embodiments, the outside diameter of the lower portion of the pipette tip and the height of the rectangular central portion both measure less than one half inch.

In another aspect, the central portion of the pipette tip is enlarged in only one lateral direction with respect to both the lower portion and the upper portion of the pipette tip to allow the pipette tip to hold the large volume of the liquid while simultaneously allowing the pipette tip to be mounted to the automated pipetting system in close proximity with an adjacent pipette tip.

In another aspect, the disclosure is directed toward a system for dispensing large volumes of fluid. The system incorporates a plurality of pipette tips and a mounting head for coupling the pipette tips to the system. The pipette tips can be as described above, and the mounting head can have a plurality of engagement features for sealingly receiving the respective pipette tips. The engagement features can be spaced apart from each other by a distance smaller than the largest lateral dimension of the pipette tips due to the tips' shape.

In another aspect, the present disclosure is directed to a method for simultaneously dispensing a large volume of liquid into several wells in a tray. The method includes providing a head having a plurality of engagement features corresponding to the plurality of wells. The respective engagement features are at least substantially alignable with the plurality of wells. The method also includes providing a plurality of pipette tips engageable with the engagement features on the head and adapted to aspirate liquid from or to respective ones of the plurality of wells. Each of the plurality of pipette tips has a first lateral dimension measuring less than the spacing between the centerlines of two adjacent engagement features. Each of the pipette tips also has a second lateral dimension, at least substantially perpendicular to the first lateral dimension, measuring more than the distance between the two centerlines. The method also includes orienting the pipette tips such that their first dimensions are aligned with each other. The method also incorporates mounting the pipette tips to the engagement features. Embodiments of this method can be used to simultaneously aspirate/dispense large volumes of liquid from/to a plurality of wells, even when the wells are in close proximity to each other.

### BRIEF DESCRIPTION OF THE SEVERAL VIEWS OF THE DRAWINGS

For a better understanding of the invention as well as other objects and further features thereof, reference is made to the following description which is to be read in conjunction with the accompanying drawing wherein:

FIG. 1 is a perspective view of a pipette tip according to an embodiment of the present invention;

FIG. 2 is a front elevation view of the pipette tip of FIG. 1;

FIG. 3 is a side elevation view of the pipette tip of FIG. 1;

FIG. 4 is a cross-sectional view of a portion of the pipette tip of FIG. 1, shown along Section 4-4 of FIG. 3;

FIG. 5 is a cross-sectional view of a portion of the pipette tip of FIG. 1, shown along Section 5-5 of FIG. 2;

FIG. 6 is a cross-sectional view of the pipette tip of FIG. 1, shown along Section 6-6 of FIG. 2;

FIG. 7 is a front elevation view of a plurality of the pipette tips of FIG. 1 installed in a liquid dispensing apparatus.

FIG. 8 is a side elevation view of a plurality of the pipette tips of FIG. 1 installed in a liquid dispensing apparatus.

### DETAILED DESCRIPTION OF THE INVENTION

The present disclosure is directed toward pipette tips adapted to be used with micropipetting apparatus to simultaneously dispense large volumes of fluids into a plurality of wells in a microplate, and for methods and systems related to the same. This specification and the associated drawings illustrate and describe several specific embodiments of such devices, systems and methods. The inventors appreciate that one of ordinary skill in the art, having reviewed this disclosure in its entirety, will appreciate that changes could be made to the details provided and illustrated in this disclosure, and that details could be eliminated from particular embodiments, all without causing the resultant embodiment to deviate from the present invention.

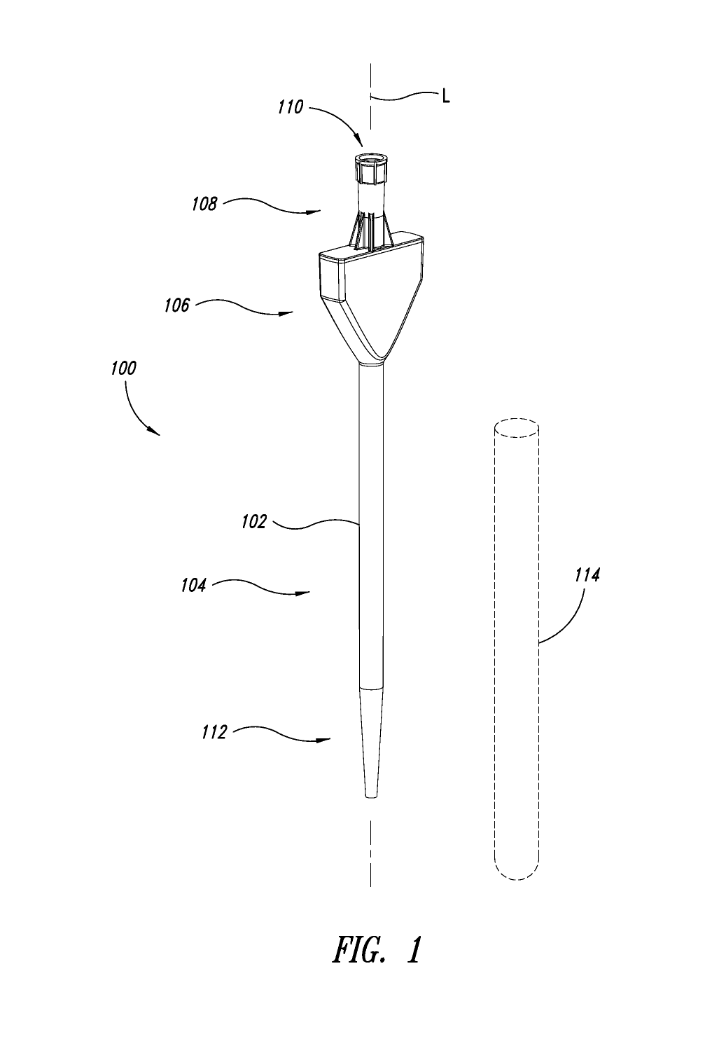

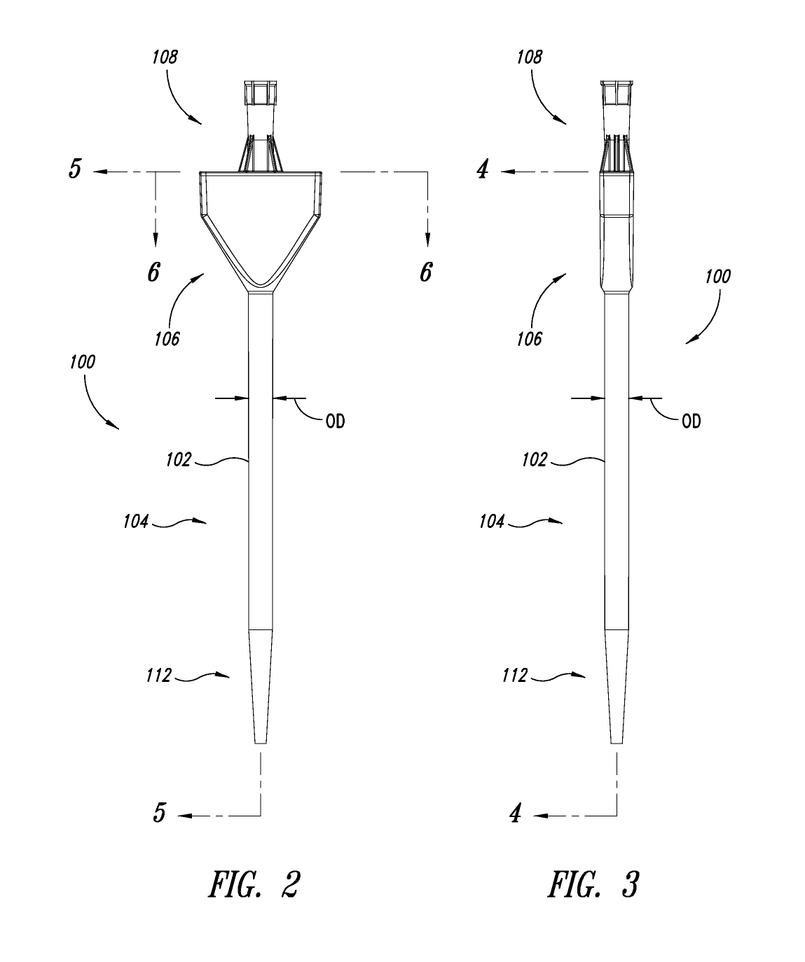

FIGS. 1-3 illustrate one particular embodiment of a pipette tip 100 for simultaneous use with a plurality of other such pipette tips to dispense large volumes of fluids. The illustrated pipette tip 100 has a body 102 with a lower portion 104, a central portion 106 and an upper portion 108. A bore 110 extends through the entire body 102 along a Longitudinal Axis L. The bore 110 is air-tight along its entire length to allow suction at one end to result in the aspiration of fluid at the other end.

The body 102 can be made from any suitable material, such as a polymer or other material having the desired characteristics for use as a pipette tip. Similarly, the body 102 can be made through any suitable method, such as injection molding or other method suitable for making a pipette tip. The body 102 can be manufactured as a single monolithic part or can be assembled from more than one part, each part being made using any of such suitable methods. The body 102 can be impregnated with a carbon material, allowing the tip 100 to be used for liquid level detection in systems such as the JANUS® system. Depending on the specific desired shapes of the lower portion 104, the central portion 106 and/or the upper portion 108, an individual of ordinary skill in the art having reviewed this entire disclosure will immediately appreciate the various materials and methods that could best be implemented to make and use the inventive pipette tip disclosed herein.

The lower portion 104 of the body 102 projects from the central portion 106 in one direction, and the upper portion 108 of the body projects from the central portion in an opposing direction. For purposes of clarity with respect to the illustrated embodiment, as oriented in the Figures, the upper portion 108 will be described as projecting from the central portion 106 in an upward direction, and the lower portion 104 will be described as projecting from the central portion in a downward direction.

The lower portion 104 of the body 102 can be formed as an elongated right cylinder or can have a gradual taper in the downward direction. A terminal end 112 of the lower portion 104 can have a frusto-conical shape to facilitate insertion of the pipette tip 100 into a test-tube 114 or the like. To further facilitate insertion of the lower portion 104 of the pipette tip 100 into a test-tube 114, the lower portion of certain embodiments can be at least three inches long, can be at least four inches long, can be at least three times as long as a length of the central portion of the pipette tip, measured along the longitudinal axis, or can be at least four times as long as the corresponding length of the central portion of the pipette tip. Similarly, to facilitate insertion of the lower portion 104 of the pipette tip 100 into a test-tube 114, the lower portion of certain embodiments can have an outside diameter OD less than half an inch, or less than a quarter inch. Thus, the lower portion 104 of the pipette tip 100 can be used to access the full volume of narrow tubes (10 mm in diameter or smaller), deep-well plates, deep-well blocks, and the like.

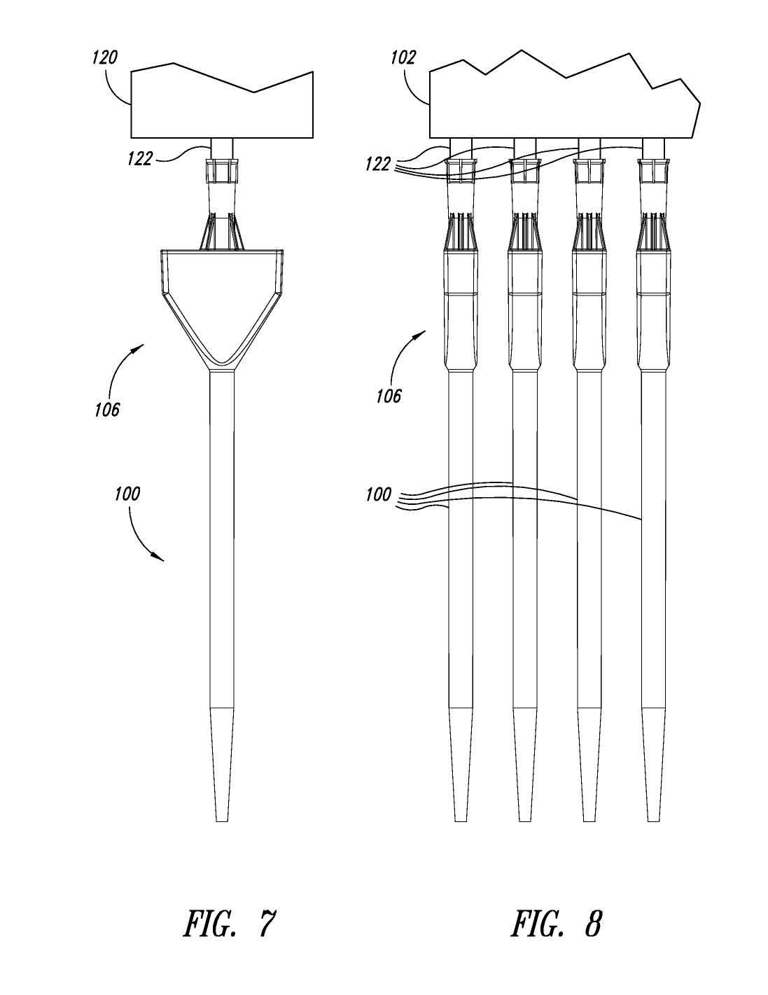

The upper portion 108 of the illustrated pipette tip 100 has a mouth 116 sized and shaped to sealingly mate with a nipple or other feature (see, e.g., FIGS. 7 and 8) on a pipetting device or system. Depending on the system, the mouth 116 can be adapted to sealingly couple to the outside of a nipple or the inside of a cylinder, or can otherwise be adapted to seal with the pipetting device, as desired.

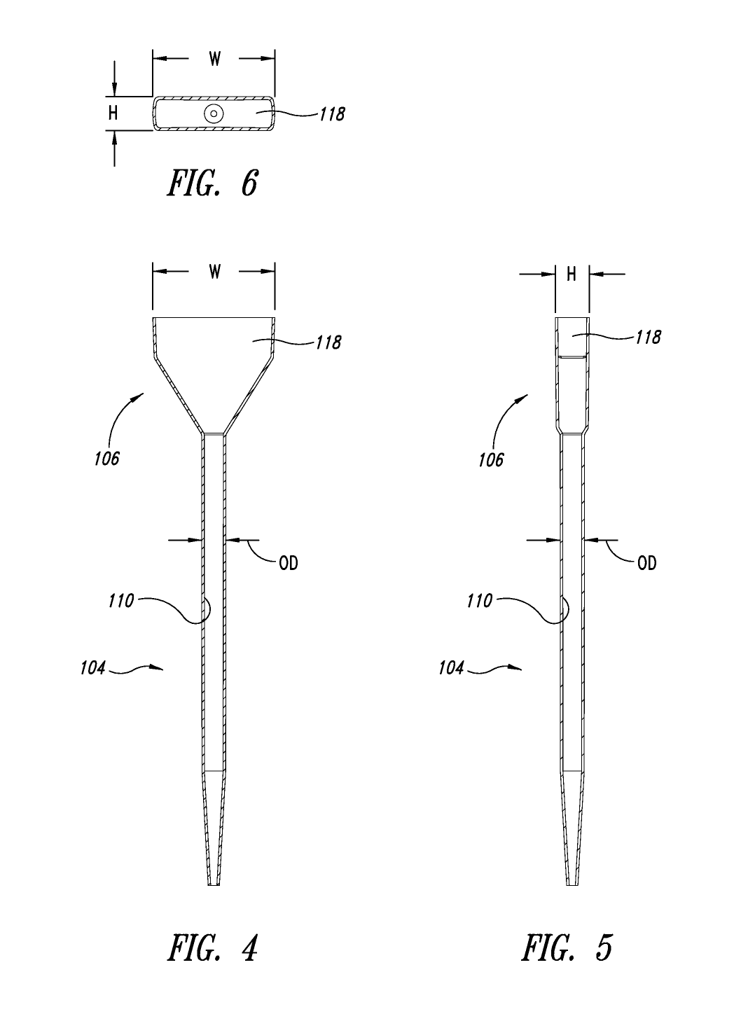

FIGS. 4-6 further illustrate the bore 110 and the central portion 106. The central portion 106 incorporates an enlarged chamber 118 for receiving liquid in volumes greater than the pipette tip 100 could otherwise hold. The illustrated chamber 118 is generally rectangular in shape, having a width W and a height H when viewed in cross-section (as in FIG. 6). The inventors appreciate that the ends of the chamber 118 need not be flat and the corners need not be angular in order for the chamber to fall within the scope and intent of the invention.

In particular embodiments, the height H of the rectangular central portion 106 can measure less than half inch or can measure less than one third inch, and/or the width W of the rectangular central portion can measure more than one inch. In other specific, non-limiting embodiments, the outside diameter OD of the lower portion 104 of the pipette tip 100 and the height H of the rectangular central portion both measure less than one half inch.

The width W of the chamber 118 can be tapered from its largest point to the point where the central portion 106 meets the lower portion 104. The taper can be smooth and gradual, with no cavities, ridges or other features that would retain liquid in the chamber when dispensed from the pipette tip 100. Such features could create inaccuracies in measurements and could otherwise prevent the pipette tip 100 from functioning for its desired purposes.

The elongated, at least substantially cylindrical lower portion 104 can enable the pipette tip 100 to provide precise measurement when micropipetting extremely small volumes, while the enlarged central portion 106 can allow the same pipette tip to receive large volumes of liquid, up to about 5 mL or more.

Meanwhile, as illustrated in FIGS. 7 and 8, the high volume pipette tip 100 can simultaneously be used along with several other similar pipette tips in an automated micropipette apparatus that incorporates a head 120 or similar structure with a plurality of nipples 122 or other sealable engagement features arranged closely in a row. Closely arranged rows of pipette tips 100 allow rows of wells in a plate or other receptacles to be filled simultaneously with large volumes of liquid even when in close proximity with each other. As shown in FIG. 8, because the height H of the enlarged central portion 106 measures the same or only slightly larger than the outside diameter ID of the lower portion 104 of the pipette tip, the pipette tips 100 can be arranged as close to each other as tips without the enlarged central portion.

In particular embodiments, eight of the pipette tips 100 can be installed in a single row on 9 mm centers, and can be used to dispense a high volume of liquid into 96 wells of a plate in twelve steps instead of 96 steps. Because the pipette tips 100 hold a large volume, each of the eight pipette tips in such a system can dispense 5 mL instead of being restricted to the small volumes typically possible in a row of tips on 9 mm centers. Even larger volume pipette tips are possible using the inventive design. An individual of ordinary skill in the art, having reviewed this entire disclosure, will immediately appreciate the changes that would be required to provide for larger volume pipetting.

One result of the present invention is that operators using automated micropipetters may be able to dispense liquids in high volumes using the same dispenser modules or arms that they would use to dispense smaller volumes. This advantage eliminates the need to replace an existing module or arm used for micropipetting with a new arm or module used for large volume pipetting.

Another result of the present invention is that the same tips can be used for both large volume pipetting and for liquid transfer to/from narrow tubes up to 120 mm or more, for accessing the bottom of deep-well blocks, for accessing the entire volume of a 10 mm diameter test tube 75 mm tall or taller, and/or for liquid level detection.

While the invention has been described with a reference to its preferred embodiment, it will be understood by those skilled in the art that various changes may be made and equivalents may be substituted for elements thereof without departing from the true spirit and scope of the invention. In addition, modifications may be made to adapt a particular situation or material to the teachings of the invention without departing from its essential teachings.

What is claimed is:

1. A pipette tip for simultaneous use with a plurality of like pipette tips in an automated pipetting system for aspirating, accurately measuring and dispensing a large volume of a liquid, the pipette tip comprising:
a body having a lower portion, an upper portion, a central portion located between the lower and upper portions, and a bore extending along a longitudinal axis through the pipette tip from the lower portion to the upper portion; the lower portion of the pipette tip being elongated and projecting in a first direction from the central portion, the lower portion being sized and shaped for insertion into a test-tube; the bore being adapted for aspirating and dispensing the large volume of the liquid; the upper portion of the pipette tip projecting from the central portion in a second direction opposing the first direction, the terminal end of the upper portion being sized and shaped to sealingly engage the pipetting system; the central portion of the pipette tip and a corresponding portion of the bore being enlarged with respect to both the upper and lower portions of the pipette tip to allow the pipette tip to hold the large volume of the liquid, the central portion having a cross-section substantially rectangular in shape in a plane perpendicular to the longitudinal axis, the cross-section of the central portion having a height at least substantially similar to the diameter of the lower portion of the pipette tip and a width significantly greater than the diameter of the lower portion of the pipette tip.

2. The pipette tip of claim 1 wherein the lower portion of the pipette tip is at least substantially cylindrical.

3. The pipette tip of claim 1 wherein the lower portion of the pipette tip is at least substantially cylindrical and at least three inches in length along the longitudinal axis.

4. The pipette tip of claim 1 wherein the lower portion of the pipette tip is at least substantially cylindrical and at least four inches in length along the longitudinal axis.

5. The pipette tip of claim 1 wherein the lower portion of the pipette tip is at least substantially cylindrical and has a length in the direction of the longitudinal axis measuring at least three times that of the central portion.

6. The pipette tip of claim 1 wherein the lower portion of the pipette tip is at least substantially cylindrical and has a length in the direction of the longitudinal axis measuring at least four times that of the central portion.

7. The pipette tip of claim 1 wherein the terminal end of the lower portion of the pipette tip is frusto-conical in shape.

8. The pipette tip of claim 1 wherein the lower portion of the pipette tip is at least substantially cylindrical and has an outside diameter measuring less than one-half of an inch.

9. The pipette tip of claim 1 wherein the lower portion of the pipette tip is at least substantially cylindrical and has an outside diameter measuring less than one-quarter of an inch.

10. The pipette tip of claim 1 wherein the lower portion of the pipette tip is at least substantially cylindrical and has an outside diameter measuring less than one-half of an inch and the central portion of the pipette tip has a height measuring less than one-half of an inch and a width measuring more than one inch.

11. The pipette tip of claim 1 wherein the central portion of the pipette tip has a height measuring approximately one-third of an inch and a width measuring more than one inch.

12. A pipette tip for simultaneous use with a plurality of like pipette tips in an automated pipetting system for aspirating, accurately measuring and dispensing a large volume of a liquid, the pipette tip comprising:
a body having a lower portion, an upper portion, a central portion located between the upper and lower portions, and a bore extending longitudinally through the pipette tip from the upper portion to the lower portion; the lower portion of the pipette tip being elongated and projecting in a first direction from the central portion and being sized and shaped for insertion into a test-tube; the bore being adapted for aspirating and dispensing the liquid; the upper portion of the pipette tip being elongated and projecting from the central portion in a second direction opposite the first direction and being adapted to sealingly engage the pipetting system; the central portion of the pipette tip being enlarged in only one lateral direction with respect to both the lower portion and the upper portion of the pipette tip to allow the pipette tip to hold the large volume of the liquid while simultaneously allowing the pipette tip to be mounted to the pipetting system in close proximity with an adjacent pipette tip.

13. The pipette tip of claim 12 wherein the central portion of the pipette tip has a cross-section taken perpendicular to the longitudinal axis that is substantially rectangular in shape.

14. The pipette tip of claim 12 wherein the central portion of the pipette tip has a cross-section taken perpendicular to the longitudinal axis that is substantially rectangular in shape, having a height less than one-tenth of an inch greater than a diameter of the lower portion of the pipette tip, and a width more than nine-tenths of an inch greater than the diameter of the lower portion.

15. The pipette tip of claim 12 wherein the bore is adapted such that substantially all of the fluid aspirated into the central and lower sections of the pipette tip can be dispensed from the pipette tip.

16. A system for simultaneously aspirating, accurately measuring and dispensing large volumes of a liquid, the system comprising:
a plurality of pipette tips, each comprising a body having a lower portion, an upper portion, a central portion located between the upper and lower portions, and a bore extending longitudinally through the pipette tip from the upper portion to the lower portion; the lower portion of the pipette tip being elongated and projecting in a first direction from the central portion; the bore being adapted for aspirating and dispensing the liquid; the upper portion of the pipette tip being elongated and projecting from the central portion in a second direction opposite the first direction and being adapted to sealingly engage the pipetting system; the central portion of the pipette tip being enlarged in only one lateral direction with respect to both the lower portion and the upper portion of the pipette tip to allow the pipette tip to hold the large volume of the liquid while simultaneously allowing the pipette tip to be mounted to the pipetting system in close proximity with an adjacent pipette tip; and
a mounting head for coupling the plurality of pipette tips to the system, the mounting head having a plurality of engagement features for sealingly receiving the respective pipette tips, the engagement features being spaced apart from each other by a distance smaller than the largest lateral dimension of the pipette tips.

17. A method for simultaneously pipetting large volumes of a liquid from a plurality of wells spaced in close proximity with each other, the method comprising:
providing a head having a plurality of engagement features corresponding to the plurality of wells, the respective engagement features being at least substantially alignable with the plurality of wells, the engagement features each having a centerline;
providing a plurality of pipette tips engageable with the engagement features on the head and adapted to aspirate liquid from or to respective ones of the plurality of wells, each of the plurality of pipette tips having a first lateral dimension measuring less than the spacing between the centerlines of two adjacent engagement features, and a second lateral dimension, at least substantially perpendicular to the first lateral dimension, measuring more than the distance between the two centerlines; and
orienting the pipette tips such that their first dimensions are aligned with each other; and
mounting the pipette tips to the engagement features.
